(19) United States
(12) Patent Application Publication
(10) Pub. No.: US 2007/0014403 A1
(43) Pub. Date: Jan. 18, 2007

(54) Controlling distribution of protected content

(75) Inventors: Chian Yi Loo, Singapore (SG); Chee Seng Ang, Singapore (SG); Chun Teck Lim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/184,507

(22) Filed: Jul. 18, 2005

(51) Int. Cl. H04N 7/167

(52) U.S. Cl. 380/201

(57) ABSTRACT

A system for controlling distribution of protected content to portable mass storage media devices (10), the system comprising: a host application (200) for a host device (20) including: collection module (202) to collect predetermined identifiers of a portable mass storage media device (10) connected to the host device (20); a first key generation module (201) to generate an encryption key using a secret key and the collected identifiers; and an encryption module (203) to encrypt protected content using the encryption key when protected content is copied to the media device (10); and a client application (100) for the portable mass storage media device (10) including: a second key generation module (101) to generate the encryption key using a secret key and predetermined identifiers of the portable mass storage media device (10); and a decryption module (102) to decrypt data relating to encrypted protected content in sector buffer memory (12) of the media device (10) using the encryption key after each read operation, to enable access to the protected content stored by the media device (10).

### TECHNICAL FIELD

The invention concerns a system for controlling distribution of protected content to portable mass storage media devices.

### BACKGROUND OF THE INVENTION

Audio files may be copied from a desktop computer to an MP3 player. In a Microsoft Windows environment, copying may be performed using the Windows Explorer application by dragging and dropping files from the desktop computer to the MP3 player. Music piracy has proliferated due to the ease of copying and transferring audio files between various hardware devices. In order to combat piracy and protect the rights of copyright owners, governments have enacted legislation banning certain forms of audio content duplication. One such country is Japan.

To comply with the laws of certain countries, there is a need to provide an effective solution without compromising the quality of the content and ease of using the playback device.

### SUMMARY OF THE INVENTION

In a first preferred aspect, there is provided an application for controlling distribution of protected content to portable mass storage media devices, the application comprising:
a key generation module to generate an encryption key using a secret key and predetermined identifiers of a portable mass storage media device; and
an encryption/decryption module to encrypt data relating to protected content in sector buffer memory of the media device using the encryption key before each write operation, and to decrypt data relating to protected content in sector buffer memory of the media device using the encryption key after each read operation.

The application may reside in firmware of the media device.

In a second aspect, there is provided a system for controlling distribution of protected content to portable mass storage media devices, the system comprising:
a host application for a host device including:
   a collection module to collect predetermined identifiers of a portable mass storage media device connected to the host device;
   a first key generation module to generate an encryption key using a secret key and the collected identifiers; and
   an encryption module to encrypt protected content using the encryption key when protected content is copied to the media device; and
a client application for the portable mass storage media device including:
   a second key generation module to generate the encryption key using a secret key and predetermined identifiers of the portable mass storage media device; and
   a decryption module to decrypt data relating to encrypted protected content in sector buffer memory of the media device using the encryption key after each read operation, to enable access to the protected content stored by the media device.

The client application may further comprise a security module to only permit protected content from the host device if copied via the host application.

In a third aspect, there is provided a method for controlling distribution of protected content to portable mass storage media devices, the method comprising:
generating an encryption key using a secret key and predetermined identifiers of a portable mass storage media device;
wherein data relating to protected content in sector buffer memory of the media device is encrypted using the encryption key before each write operation, to ensure that protected content stored by the media device is encrypted; and
wherein data relating to encrypted protected content in sector buffer memory of the media device is decrypted using the encryption key after each read operation, to enable access to the protected content stored by the media device. The method may further comprise an initial step of determining whether the data for a read/write operation to the media device is related to protected content, and if not, no encryption or decryption is performed on the content.

The protected content may be encrypted using Tiny Encryption Algorithm (TEA).

The predetermined identifiers may include a vendor identification code, production identification code, and a product key.

The encryption key may be generated by a bit-wise exclusive-or operation between the secret key and the predetermined identifiers.

Protected content may include audio content, video content, documents and images.

### BRIEF DESCRIPTION OF THE DRAWINGS

An example of the invention will now be described with reference to the accompanying drawings, in which:

FIG. 1 is a block diagram of a system for controlling distribution of protected content in accordance with the present invention;

FIG. 2 is a process flow diagram of encryption on the host device;

FIG. 3 is a process flow diagram of encryption on the media device;

FIG. 4 is a process flow diagram of decryption on the host device; and

FIG. 5 is a process flow diagram of decryption on the media device.

### DETAILED DESCRIPTION OF THE DRAWINGS

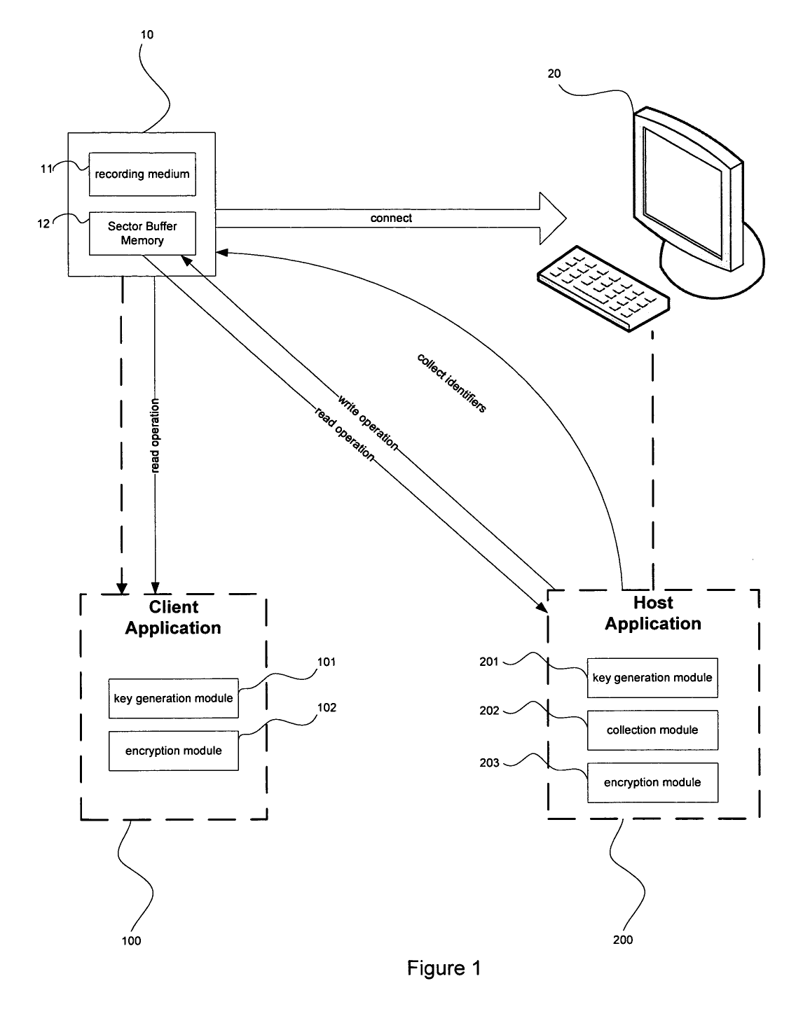

FIG. 1 and the following discussion are intended to provide a brief, general description of a suitable computing environment in which the present invention may be implemented. Although not required, the invention will be described in the general context of computer-executable instructions, such as program modules, being executed by a personal computer. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring to FIG. 1, a system for controlling distribution of protected content between portable mass storage media devices 10 and host devices 20 is provided. Portable mass storage media devices 10 include MP3 players capable of audio playback and storage of general files or Portable Video Players (PVPs) such as the Creative Zen Portable Media Center™. Host devices 20 include desktop computers, notebook computers or another portable mass storage media device 10. The system comprises a host application 200 for the host computer 20. The host application 200 includes a collection module 202, a key generation module 201 and an encryption/decryption module 203. The collection module 202 collects predetermined identifiers of the media device 10 connected to the host computer 20. Predetermined identifiers include a 16-bit vendor identification code, 16-bit production identification code, and a 64-bit product key of the media device 10. The 64-bit product key is a unique key for each media device 10. The key generation module 201 generates a 128-bit encryption key using a 128-bit secret key and the collected identifiers by performing a bitwise exclusive-or operation between the secret key and the collected identifiers. Alternatively, the key generation module 201 generates an encryption key using a combination of a generic hash operation on the secret key and the collected identifiers. The encryption/decryption module 203 encrypts/decrypts protected content using the encryption key when protected content is copied to/from the media device 10. Protected content includes MP3 audio files and MPEG video files.

The system also comprises a client application 100 for the media device 10. The client application 100 includes a key generation module 101 and an encryption/decryption module 102. The key generation module 101 generates the encryption key using a secret key and the predetermined identifiers of the media device 10. Data relating to encrypted protected content in sector buffer memory 12 of the media device 10 is decrypted using the encryption key after each read operation, to enable access to the protected content stored by the media device 10. A security module only permits copying protected content from the computer 20 if it is copied via the host application 200.

In one example, the encryption algorithm used is Tiny Encryption Algorithm (TEA). In this example, the golden ratio is unchanged and is the recommended value. The loop iteration is changed to eight to reduce processing power because encryption/decryption is implemented on an embedded platform.

The encryption key, E_{K} is generated using a hash function as follows: E_{K}=HASH(S_{K} P_{K}), where HASH is a generic hash function found in a common key generation method, S_{K} is the secret key and P_{K} is a collected identifier(s) unique to each media device 10.

An exemplary hash function which may be used is the FNV-1 hash function. HASH(S_{K},P_{K}), where S_{K} is the 128-bit secret key and P_{K} is a collection of identifiers unique to the media device 10 up to 128-bits.

S_{K} and P_{K} are each broken down into a 32-bit value. The hash function performs the following operation generating the encryption key, E_{K}.

```
hash_value = previous_hash_value;
repeat 4 times {
  FNV_MUL(hval);
  hash_value \hat{ }= GET_NEXT_BYTE(SK);
  FNV_MUL(hval);
  hash_value \hat{ }= GET_NEXT_BYTE(PK);
}
```

where FNV_MUL(h) is h+=(h<<1)+(h<<4)+(h<<7)+(h<<8)+(h<<24);

Encryption and decryption are implemented on the sector buffer memory 12 of the media device 10 for all read/write operations on the media device 10. The sector buffer memory 12 is a temporary memory to store the data read from a file or data about to be written to a file on the recording medium 11. Data stored in sector buffer memory 12 must decrypted before it is read by other programs.

When the sector buffer memory 12 is committed to a file during a write operation, the sector buffer memory 12 is encrypted before the actual write operation to the recording medium 11. During a read operation, the sector buffer memory 12 is decrypted immediately after reading a file. This enables easy reading or writing of data on an embedded system since the encryption and/or decryption is performed only once. This also allows transparency of implementing the encryption from other portions of the firmware. This prevents any change to non-related portions of the firmware and enables easy source code maintenance.

The system enables users to transfer and playback protected audio content via their device 10. Compliance with copyright law of certain countries is achieved by preventing the same content to be copied and playback on non-authorised devices.

Sample use cases for the user are described in the following typical usage scenarios:

A) Transfer and Playback of Protected Audio Content

The user connects the portable media device 10 to the host computer 20. The host computer 20 detects the media device 10, and automatically launches the host application 200. The host application 200 provides an interface with the media device 10. The host application 200 enables the user to drag and drop audio files into the device. The host application 200 detects whether an audio file is to be protected. If protection is required, the host application 200 encrypts the audio file and transfers it to the device. After the transfer session is completed, the user disconnects the media device 10 from the host computer 20. The user turns on the media device 10 and commences playback of the audio files transferred to the media device 10.

B) Backup of General Data Files (Non-Protected Content)

The user connects the portable media device 10 to the host computer 20. The host computer 20 detects the media device 10, and automatically launches the host application 200. Alternatively, the user uses a file manager of the operating system in the host computer 20 to drag and drop data files to the media device 10 for the purpose of backup. For example, the file manager may be the Microsoft Windows Explorer application for Microsoft Windows XP. If the host application 200 is used, no encryption is performed since it detects that these files are general data files based on their file extensions such as PDF, DOC, XLS, TXT and so forth. The files are copied to the media device 10. After all the data files are transferred, the user disconnects the media device 10 from the computer 20. When the user requires the backed up data files, the media device 10 is connected to a computer 20 and the data files are copied using either the host application 200 or the file manager.

C) Playback of Protected Audio Content on an Unauthorized Device

The user is prevented from copying protected files to another unauthorized device using the host application 200. If the user copies the protected file to the computer 20 using the file manager of the host computer 20, the protected file remains encrypted and thus is not recognized by the host computer 20. This unrecognizable file is unable to be played by any audio decoder. If the user directly copies the protected file to another media device 10, the protected file remains encrypted and is unable to be accessed without the correct encryption key.

Encryption on the Host

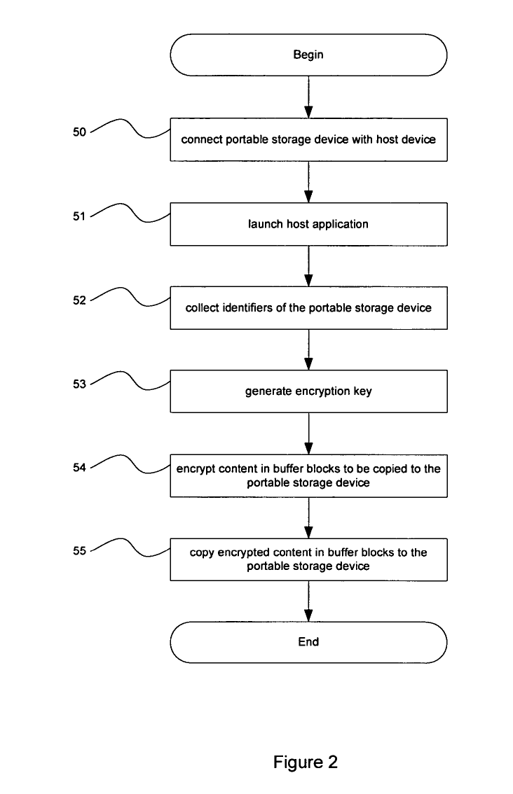

Referring to FIG. 2, the media device 10 is connected 50 to the computer 20. The operating system of the computer 20 detects the connection of the media device 10 and automatically launches 51 the host application 200. The collection module 202 of the host application 200 collects 52 the vendor identification code, production identification code, and a product key of the media device 10. The key generation module 201 of the host application 200 generates 53 an encryption key using a secret key and the vendor identification code, production identification code, and the product key of the media device 10. The encryption key is passed to the encryption module 203 where the protected audio content is encrypted 54 in buffer blocks using TEA. The content which is encrypted in buffer blocks is later copied 55 to the media device 10.

Encryption on the Device

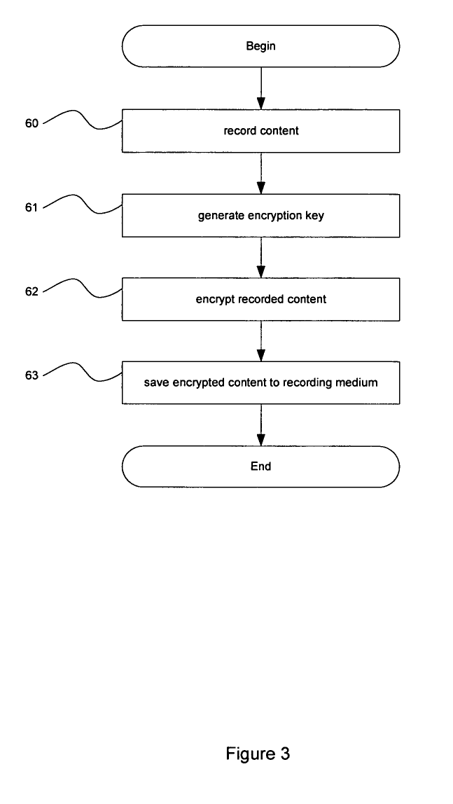

Referring to FIG. 3, in instances where the media device 10 records 60 content using a microphone or line-in/AV-in jack, encryption is performed on the recorded content. The client application 100 of the media device 10 retrieves its vendor identification code, production identification code, and product key. The key generation module 101 of the client application 100 generates 61 an encryption key using a secret key and the vendor identification code, production identification code, and the product key. Before the recorded content is written 63 to the recording medium 11, it is encrypted 62 by the encryption module 102 using the encryption key with TEA.

Decryption on the Host

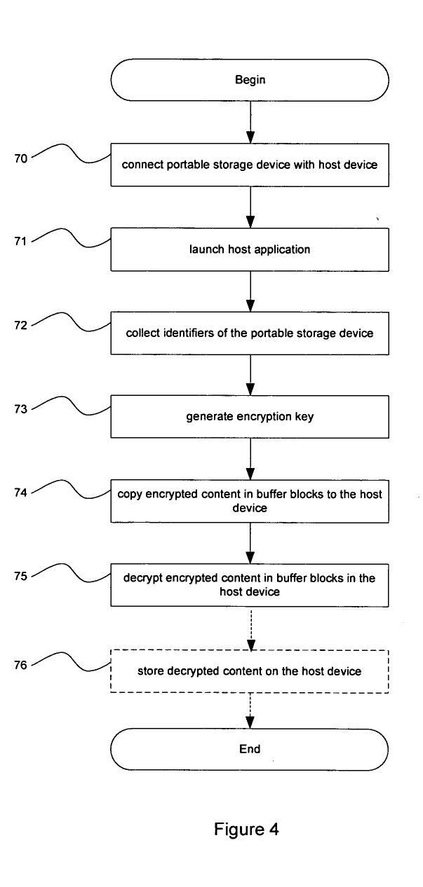

Referring to FIG. 4, only authorized recorded content is permitted to be copied to the computer 20 for decryption. The media device 10 is connected 70 to the computer 20. The operating system of the computer 20 detects the connection of the media device 10 and automatically launches 71 the host application 200. The collection module 202 of the host application 200 collects 72 the vendor identification code, production identification code, and a product key of the media device 10. The key generation module 201 of the host application 200 generates 73 an encryption key using a secret key and the vendor identification code, production identification code, and the product key of the media device 10. Content to be copied from the media device 10 to the computer 20 are selected and copied 74 in encrypted form in buffer blocks. The encryption key is passed to the encryption module 203 where the protected audio content in buffer blocks is decrypted 75 using TEA. A copy of the decrypted content may be stored 76 on the computer 20.

Decryption on the Device

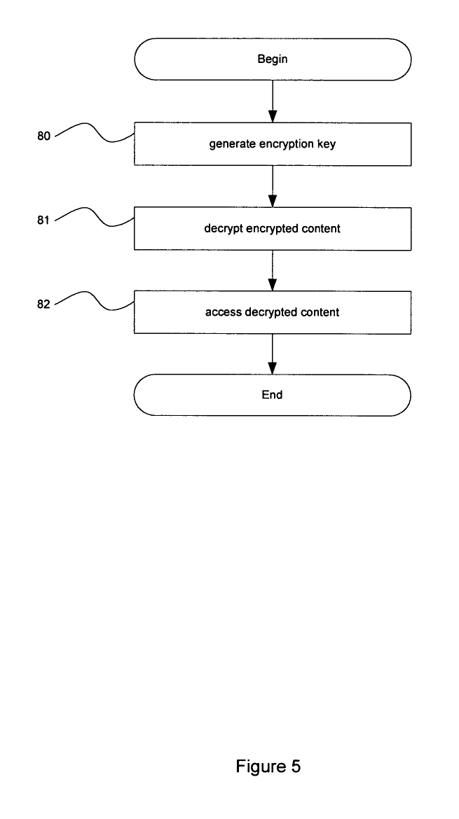

Referring to FIG. 5, the client application 100 of the media device 10 retrieves its vendor identification code, production identification code, and product key. The key generation module 101 of the client application 100 generates 80 an encryption key using a secret key and the vendor identification code, production identification code, and the product key. Before the encrypted content is accessed 82, it is decrypted 81 by the encryption module 102 using the encryption key together with TEA. Protected audio content that is copied from another media device 10 will not be accessible since the correct encryption key is not generated as the two media devices 10 possess different properties. Thus any decrypted content will not playback correctly.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. An application for controlling distribution of protected content to portable mass storage media devices, the application comprising:
a key generation module to generate an encryption key using a secret key and predetermined identifiers of a portable mass storage media device; and
an encryption/decryption module to encrypt data relating to protected content in sector buffer memory of the media device using the encryption key before each write operation, and to decrypt data relating to protected content in sector buffer memory of the media device using the encryption key after each read operation.

2. The application according to claim 1, wherein the application resides in firmware of the media device.

3. A system for controlling distribution of protected content to portable mass storage media devices, the system comprising:
a host application for a host device including:
a collection module to collect predetermined identifiers of a portable mass storage media device connected to the host device;
a first key generation module to generate an encryption key using a secret key and the collected identifiers; and
an encryption module to encrypt protected content using the encryption key when protected content is copied to the media device; and
a client application for the portable mass storage media device including:
a second key generation module to generate the encryption key using a secret key and predetermined identifiers of the portable mass storage media device; and
a decryption module to decrypt data relating to encrypted protected content in sector buffer memory of the media device using the encryption key after each read operation, to enable access to the protected content stored by the media device.

4. The system according to claim 3, wherein the client application further comprises a security module to only permit protected content from the host device if copied via the host application.

5. A method for controlling distribution of protected content to portable mass storage media devices, the method comprising:
generating an encryption key using a secret key and predetermined identifiers of a portable mass storage media device;
wherein data relating to protected content in sector buffer memory of the media device is encrypted using the encryption key before each write operation, to ensure that protected content stored by the media device is encrypted; and
wherein data relating to encrypted protected content in sector buffer memory of the media device is decrypted using the encryption key after each read operation, to enable access to the protected content stored by the media device.

6. The method according to claim 5, further comprising determining whether the data for a read/write operation to the media device is related to protected content, and if not, no encryption or decryption is performed on the content.

7. The method according to claim 5, wherein the protected content is encrypted using a block cipher.

8. The method according to claim 7, wherein the block cipher is Tiny Encryption Algorithm (TEA).

9. The method according to claim 5, wherein the predetermined identifiers include a vendor identification code, production identification code, and a product key.

10. The method according to claim 9, wherein the encryption key is generated by a bit-wise exclusive-or operation between the secret key and the predetermined identifiers.

11. The method according to claim 9, wherein the encryption key is generated by a combination of a generic hash operation on the secret key and the predetermined identifiers.

12. The method according to claim 5, wherein protected content includes audio content, video content, documents and images.

13. A portable mass storage media device comprising an application for controlling distribution of protected content, the application comprising:
a key generation module to generate an encryption key using a secret key and predetermined identifiers of the portable mass storage media device; and
an encryption/decryption module to encrypt data relating to protected content in sector buffer memory of the media device using the encryption key before each write operation, and to decrypt data relating to protected content in sector buffer memory of the media device using the encryption key after each read operation.
